(19) United States
(12) Patent Application Publication
(10) Pub. No.: US 2026/0290266 A1
(43) Pub. Date: Sep. 24, 2026

(54) ELECTRONIC PAPER DISPLAY DEVICE AND DRIVING METHOD THEREOF

(71) Applicant: E Ink Holdings Inc., Hsinchu (TW)

(72) Inventors: Chi-Liang Wu, Hsinchu (TW); Wei-Tsung Chen, Hsinchu (TW); Chia-Hao Kuo, Hsinchu (TW); Xue-Hung Tsai, Hsinchu (TW)

(73) Assignee: E Ink Holdings Inc., Hsinchu (TW)

(21) Appl. No.: 19/564,172

(22) Filed: Mar. 12, 2026

Related U.S. Application Data
(60) Provisional application No. 63/774,112, filed on Mar. 19, 2025.

(51) Int. Cl. G09G 3/34

(52) U.S. Cl. CPC G09G 3/344; G09G 2300/0408; G09G 2310/0267; G09G 2320/0247; G09G 2330/021

(57) ABSTRACT

An electronic paper display (EPD) device and a driving method thereof are provided. An EPD panel and a gate driver on array (GOA) of the EPD device are disposed on an EPD substrate. The EPD panel includes N scan lines. The N scan lines are divided into M groups of scan lines, each group of scan lines includes at least one scan line. The driving method includes: by controlling the gate driver on array, interlaced scanning is performed on the M groups of scan lines, the interlacing spanning K groups of scan lines.

### CROSS-REFERENCE TO RELATED APPLICATION

This application claims the priority benefit of the U.S. provisional application Ser. No. 63/774,112, filed on Mar. 19, 2025. The entirety of the above-mentioned patent application is hereby incorporated by reference herein and made a part of this specification.

### BACKGROUND

### Technical Field

The disclosure relates to a technology of electronic paper display (EPD), and particularly relates to an electronic paper display device and a driving method thereof.

### Description of Related Art

An electronic paper display may utilize incident light (e.g., sunlight, indoor ambient light, etc.) to illuminate an electronic ink layer to display a frame, thus a backlight source is not required. Furthermore, the electronic paper display only needs to scan and update data on the display panel when switching frames, and does not need to consume power to maintain the frame as liquid crystal displays or light emitting diode displays do, thus power consumption is further reduced.

When the electronic paper display switches frames, since the scanning and updating of the display panel adopts a progressive scan method, users may perceive a relatively strong frame flickering sensation. Thus, how to reduce the frame flickering sensation when the electronic paper display switches frames is a research direction.

### SUMMARY

The disclosure provides an electronic paper display device and a driving method thereof, which may reduce the frame flickering sensation when the electronic paper display switches frames.

The disclosure provides a driving method of an electronic paper display device. An EPD panel and a gate driver on array in the electronic paper display device are disposed on an electronic paper display substrate, the EPD panel includes N scan lines, where the N scan lines are divided into M groups of scan lines, each of the M groups of scan lines includes at least one scan line, and N and M are positive integers and N is an even number. The driving method includes: performing interlaced scanning with spanning K groups of scan lines on the M groups of scan lines in the EPD panel based on controlling the gate driver on array, where K is less than M and K is a positive integer. The interlaced scanning with spanning the K groups of scan lines includes: at a first time period, sequentially scanning from a first group of scan lines of a start frame to a Kth group of scan lines of the start frame; and at a second time period after the first time period, scanning an Ath group of scan lines in the start frame and a plurality of frames, then scanning an (A+K)th group of scan lines, where A is a positive integer of a cycle count, and 1≤A≤M.

The electronic paper display device of the disclosure includes an EPD panel, a display controller, and a gate driver on array. The EPD panel includes N scan lines. The N scan lines are divided into M groups of scan lines, each of the M groups of scan lines includes at least one scan line, and N and M are positive integers and N is an even number. The gate driver on array is coupled to the display controller and the EPD panel. The EPD panel and the gate driver on array are disposed on an electronic paper display substrate. The display controller controls the gate driver on array so as to perform interlaced scanning with spanning K groups of scan lines on the M groups of scan lines in the EPD panel, where K is less than M and K is a positive integer. The interlaced scanning with spanning the K groups of scan lines includes: at a first time period, sequentially scanning from a first group of scan lines of a start frame to a Kth group of scan lines of the start frame; and at a second time period after the first time period, scanning an Ath group of scan lines in the start frame and a plurality of frames, then scanning an (A+K)th group of scan lines, where A is a positive integer of a cycle count, and 1≤A≤M.

Based on the above, the embodiment of the disclosure performs frame scanning and updating on the electronic paper display through an interlaced scanning with spanning a fixed number of groups of scan lines, so as to reduce the frame flickering of the electronic paper display when switching frames. In this embodiment, the trigger signal Vst is triggered twice in the same frame, thereby generating two trigger transmissions for the gate driver on array (GOA), allowing these two trigger transmissions to be performed simultaneously, thereby implementing interlaced scanning of the scan line signals in the gate array. The embodiment of the disclosure also has corresponding start frame and ending frame before and after performing the interlaced scan, thereby further improving the corresponding implementation details of the interlaced scan. Furthermore, this embodiment may adopt a scan grouping method while using the aforementioned interlaced scan, configuring each group of scan lines to have more than one scan line, which may enable the data driver to effectively reduce the interlace count of the output data, and may further reduce the frame flickering of the electronic paper display when switching frames.

### BRIEF DESCRIPTION OF THE DRAWINGS

FIG. 1 is a schematic diagram of an electronic paper display device according to an embodiment of the disclosure.

FIG. 2 is a flowchart illustrating a driving method of an electronic paper display device according to an embodiment of the disclosure.

FIG. 3 is a schematic diagram illustrating interlaced scanning with spanning multiple groups of scan lines according to a first embodiment of the disclosure.

FIG. 4 is a detailed example schematic diagram illustrating interlaced scanning with spanning multiple groups of scan lines in the first time period according to a first embodiment of the disclosure.

FIG. 5 is a detailed example schematic diagram illustrating interlaced scanning with spanning multiple groups of scan lines in the second time period according to a first embodiment of the disclosure.

FIG. 6 is a detailed example schematic diagram illustrating interlaced scanning with spanning multiple groups of scan lines in the third time period according to a first embodiment of the disclosure.

FIG. 7 is a schematic diagram illustrating a detailed structure of a gate driver on array according to a first embodiment of the disclosure.

FIG. 8 is a signal waveform diagram of the enable signals, the voltage-controlled clock signals, and the reset signals in FIG. 7.

FIG. 9A and FIG. 9B are schematic diagrams illustrating interlaced scanning with spanning multiple groups of scan lines implemented by each group of scan lines having 2 or 4 scan lines according to various embodiments of the disclosure.

FIG. 10 is a circuit structure diagram of a gate array stage circuit when each group of scan lines has 4 scan lines according to a second embodiment of the disclosure.

FIG. 11 is a schematic diagram of signal waveforms of each signal in the gate array stage circuit of FIG. 10.

FIG. 12 is a signal waveform diagram of the enable signal, the voltage-controlled clock signal, and the reset signal in the second embodiment corresponding to FIG. 9B.

### DESCRIPTION OF THE EMBODIMENTS

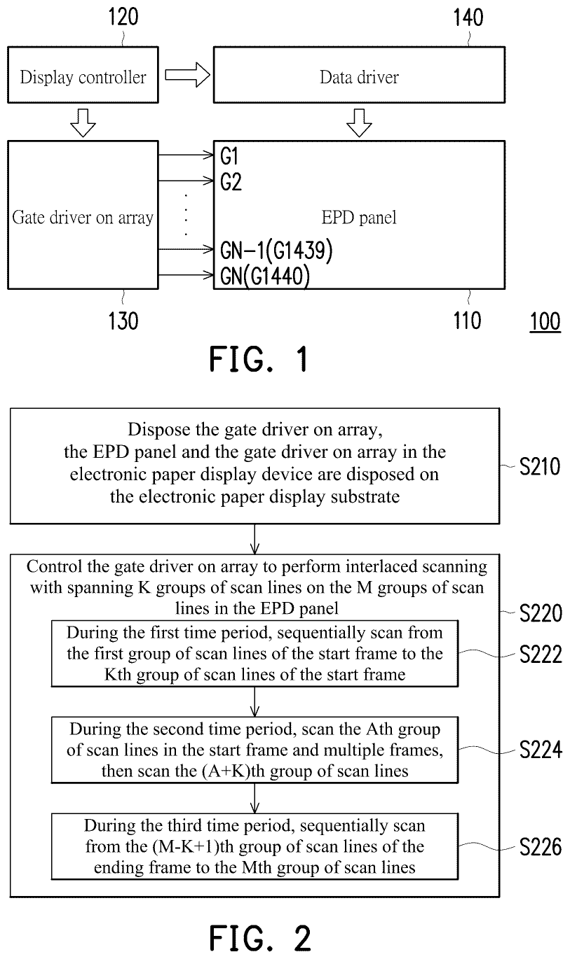

FIG. 1 is a schematic diagram of an electronic paper display device 100 according to an embodiment of the disclosure. The electronic paper display device 100 mainly includes an EPD panel 110, a display controller 120, and a gate driver on array (GOA) 130. The electronic paper display device 100 further includes a data driver 140.

The EPD panel 110 includes N scan lines G1 to GN. Nis a positive integer and N is an even number. In this embodiment, the resolution of the EPD panel 110 is exemplified as 1920×1440, that is, the EPD panel 110 has 1440 scan lines (i.e., N is 1440), and each scan line has 1920 pixel units. The display controller 120 is, for example, a timing controller, configured to control the gate driver on array 130 and the data driver 140 to refresh display data on the EPD panel 110 through the scan lines G1 to GN. The display controller 120 may control the gate driver on array 130 and the data driver 140 by providing signals such as a voltage-controlled clock signal, a vertical synchronization signal, a reset signal, and the like.

The gate driver on array 130 and the EPD panel 110 of this embodiment are disposed on the same electronic paper display substrate. The gate driver on array 130 may rapidly enable the corresponding scan lines G1 to GN, and the data driver 140 may rapidly provide data on one of the enabled scan lines G1 to GN to multiple pixel units on one of the enabled scan lines G1 to GN.

The N scan lines of this embodiment are divided into M groups of scan lines. Mis a positive integer. Each of the M groups of scan lines includes at least one scan line. One of the purposes of grouping the scan lines is to enable the data driver to effectively reduce the interlace count of the output data, which may further reduce the frame flickering of the electronic paper display when switching frames. Since the data values of pixels on adjacent scan lines may be relatively close, for example, the frame usually has larger areas of same-color blocks, when the data driver adopts a scan grouping method (that is, configuring each group of scan lines to have more than one scan line) to provide data on the scan lines, the data driver may effectively reduce the interlace count of the output data, thereby further reducing the power consumption of the electronic paper display device 100.

For convenience of describing the related technical features, M equals N in the first embodiment, that is, each of the M groups of scan lines has only one scan line. M equals N/4 in the second embodiment, that is, each of the M groups of scan lines has four scan lines. Those applying this embodiment may correspondingly adjust the quantity of scan lines in each group of scan lines according to their requirements.

The display controller 120 controls the gate driver on array 130 to perform interlaced scanning with spanning K groups of scan lines on the M groups of scan lines in the EPD panel 110. K is less than M and K is a positive integer. In detail, interlaced scanning with spanning K groups of scan lines include, in a first time period, the display controller 120 sequentially scans from the first group of scan lines of the start frame to the Kth group of scan lines of the start frame. In a second time period after the first time period, the display controller 120 scans the Ath group of scan lines in the start frame and multiple frames, and then scans the (A+K)th group of scan lines. A is a positive integer of a cycle count, and 1≤A≤M. Furthermore, in a third time period after the second time period, the display controller 120 sequentially scans from the (M-K+1)th group of scan lines of the ending frame to the Mth group of scan lines. The aforementioned ending frame is presented after the aforementioned multiple frames. The interlaced scanning will be described in more detail in the following embodiments.

In this embodiment, the value of K may be determined by those applying this embodiment according to their requirements, and K is not 0. Assuming Nis 1440 and N equals M, the quantity of the spanned K groups of scan lines may be 360 (i.e., N/4, one-quarter of the scan line spacing on the panel), 480 (i.e., N/3, one-third of the scan line spacing on the panel), or 1080 (i.e., 3N/4, three-quarters of the scan line spacing on the panel).

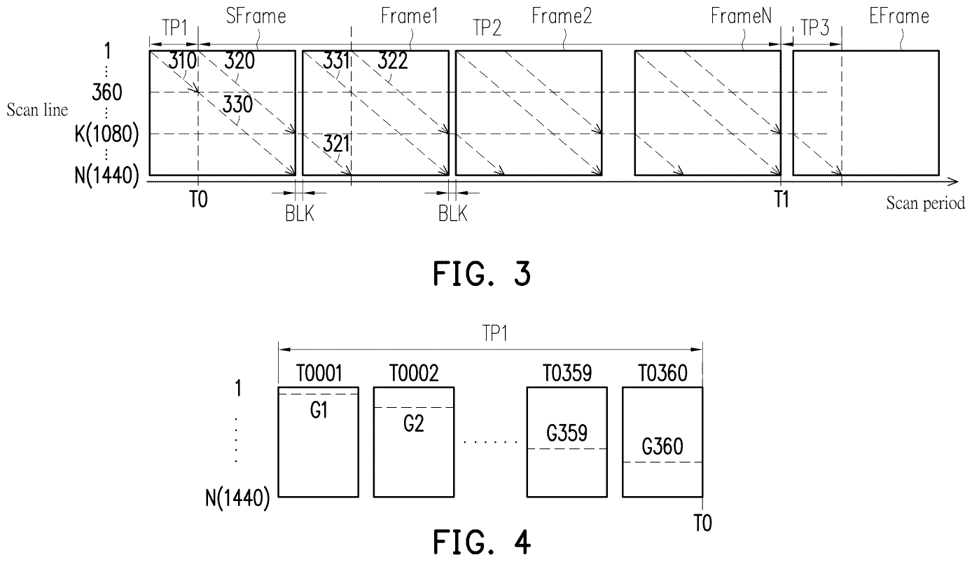

FIG. 2 is a flowchart illustrating a driving method of an electronic paper display device according to an embodiment of the disclosure. FIG. 3 is a schematic diagram illustrating interlaced scanning with spanning multiple groups of scan lines according to a first embodiment of the disclosure.

For convenience of describing this embodiment, “interlaced scanning with spanning K groups of scan lines” is abbreviated as “span interlaced scanning” herein. FIG. 3 takes an EPD panel 110 with 1920×1440 resolution as an example, and the EPD panel 110 has 1440 scan lines G1 to GN. Here, one-quarter of the scan line spacing on the panel (i.e., K is 360) is used as an example to describe the details of “span interlaced scanning”.

Referring to FIG. 2 and FIG. 3 simultaneously, in step S210, the gate driver on array 130 is disposed on the electronic paper display substrate. The EPD panel 110 and the gate driver on array 130 in the electronic paper display device 100 are disposed on the electronic paper display substrate. The EPD panel 110 includes N scan lines, and Nis 1440 in this embodiment. The N scan lines of this embodiment are divided into M groups of scan lines. Each of the M groups of scan lines includes at least one scan line, N and M are positive integers, and Nis an even number. M equals N in the first embodiment, that is, each of the M groups of scan lines has only one scan line.

In step S220, the display controller 120 controls the gate driver on array 130 to perform interlaced scanning with spanning K groups of scan lines on the M groups of scan lines in the EPD panel 110. Step S220 includes step S222 to step S226.

Referring to FIG. 2 and FIG. 3 simultaneously, in step S222, during the first time period TP1, the display controller 120 sequentially scans from the first group of scan lines (e.g., the first group of scan lines G1) of the start frame SFrame to the Kth group of scan lines (e.g., the Kth group of scan lines G360, K is 360 in this embodiment) of the start frame SFrame, as indicated by the dashed arrow 310. The end of the first time period TP1 is the time point T0. The start frame SFrame is mainly to enable the first trigger transmission to proceed smoothly, so as to subsequently enable the two trigger transmissions in the second time period TP2 to proceed simultaneously.

FIG. 4 is a detailed example schematic diagram illustrating interlaced scanning with spanning multiple groups of scan lines in the first time period TP1 according to a first embodiment of the disclosure. FIG. 4 is illustrated according to the scan lines G1 to G360 being driven in each start frame SFrame and the time being driven. During the scan period T0001 in the first time period TP1, the first group of scan lines G1 of the start frame SFrame is scanned, during the scan period T0002, the second group of scan lines G2 of the start frame SFrame is scanned . . . and so on, during the scan period T0360, the 360th group of scan lines G360 of the start frame SFrame is scanned.

Returning to FIG. 2 and FIG. 3, in step S224, during the second time period TP2 after the first time period TP1, the display controller 120 scans the Ath group of scan lines in the start frame SFrame and multiple frames Frame1 to FrameN, then scans the (A+K)th group of scan lines. A is a positive integer of a cycle count, and 1≤A≤M. The quantity of frames Frame1 to FrameN is not necessarily equal to N (1440), here it refers to an arbitrary quantity of frames. The second time period TP2 is between the time point T0 and T1. For example, in the start frame SFrame, the display controller 120 first scans the first group of scan lines (A equals 1 at this time), as the first point on the dashed arrow 320. Then, the display controller 120 scans the 361st group of scan lines G361 ((A+K) equals 361 at this time), as the first point on the dashed arrow 330. Next, the display controller 120 scans the second group of scan lines G2 (A equals 2 at this time), as the second point on the dashed arrow 320. Then, the display controller 120 scans the 362nd group of scan lines G362 ((A+K) equals 362 at this time), as the second point on the dashed arrow 330. And so on, until the display controller 120 scans the 1080th group of scan lines G1080 (A equals 1080 at this time), as the last point on the dashed arrow 320 located at the start frame SFrame, then, the display controller 120 scans the 1440th group of scan lines G1440 ((A+K) equals 1440 at this time), as the last point on the dashed arrow 330 located at the start frame SFrame.

A blanking interval BLK is provided between the start frame SFrame and the frame Frame1. During the frame Frame1 of the second time period TP2, the display controller 120 first scans the 1081st group of scan lines G1081 (A equals 1081 at this time), as a point on the dashed arrow 321 following the dashed arrow 320. Then, the display controller 120 scans the first group of scan lines G1 ((A+K) equals 1441 at this time, but M is only 1440, thus the first group of scan lines G1 is scanned), as a point on the dashed arrow 331. Moreover, the display controller 120 scans the 1082nd group of scan lines G1082 (A equals 1082 at this time), as another point on the dashed arrow 321. Then, the display controller 120 scans the second group of scan lines G2 ((A+K) equals 1442 at this time, but M is only 1440, thus the second group of scan lines G2 is scanned), as another point on the dashed arrow 331, and so on.

For the scan order of scan lines in the dashed arrow 322 and the dashed arrow 331 in the frame Frame1, it is referred to the scan order of scan lines in the dashed arrow 320 and the dashed arrow 330 in the start frame SFrame. In other words, during the second time period TP2, the display controller 120 is implementing span interlaced scanning.

The EPD panel 110 in this embodiment only has 1440 scan lines, and M equals 1440 in this embodiment. Thus, in response to (A+K) (1441) being greater than M (1440), scanning the (A+K)th (1441st) group of scan lines is changed to scanning the (A+K−M)th (1st) group of scan lines. Moreover, in response to (A+1) being greater than M (1440), scanning the (A+1)th group of scan lines is changed to scanning the (A+1-M)th group of scan lines.

The dashed arrow 310 and the dashed arrow 330 in the start frame SFrame of FIG. 3 present the first trigger transmission. When the dashed arrow 330 ends, the first trigger transmission continues from the dashed arrow 331 in the frame Frame1. The dashed arrow 320 in the start frame SFrame of FIG. 3 and the dashed arrow 321 in the frame Frame1 present the second trigger transmission. When the dashed arrow 321 ends, the second trigger transmission continues from the dashed arrow 322 in the frame Frame1. In this way, this embodiment may enable these two trigger transmissions to be performed simultaneously, thereby implementing span interlaced scanning of scan line signals in the gate array.

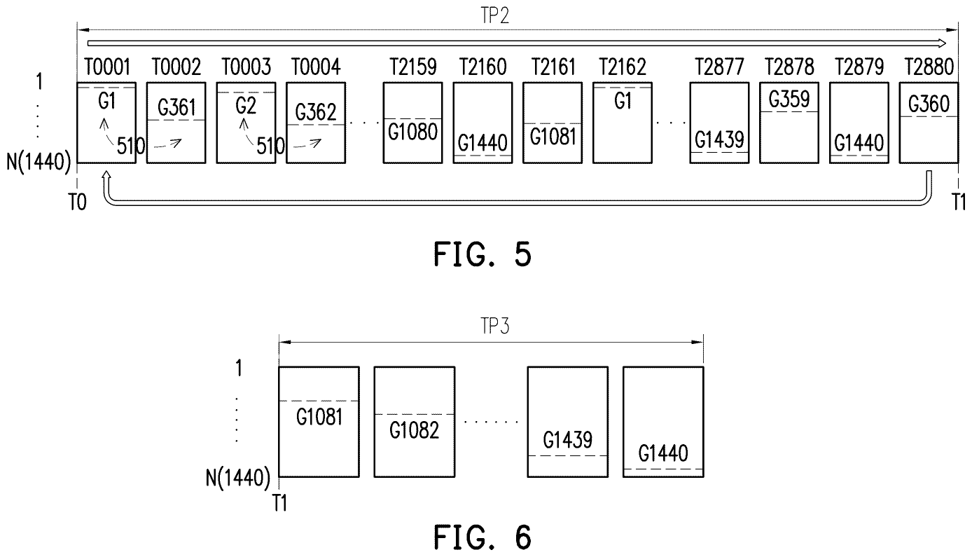

FIG. 5 is a detailed example schematic diagram illustrating interlaced scanning with spanning multiple groups of scan lines in the second time period TP2 according to a first embodiment of the disclosure. Similar to FIG. 4, FIG. 5 is illustrated according to the driven scan lines G1 to G1081 and the driven time in each start frame SFrame and frames Frame1 to FrameN. The scan periods T0001 to T2880 in FIG. 5 only indicate the scan order of these scan lines. The scan periods T0001 to T0360 in FIG. 4 are not the scan periods T0001 to T2880 in FIG. 5.

Referring to FIG. 5, during the scan period T0001 in the second time period TP2, the first group of scan lines G1 (A equals 1) of the start frame SFrame or frames Frame1 to FrameN is scanned; during the scan period T0002, the 361st group of scan lines G361 (A+K equals 361) of the start frame SFrame or frames Frame1 to FrameN is scanned. During the scan period T0003, the second group of scan lines G2 (A equals 2) of the start frame SFrame or frames Frame1 to FrameN is scanned. During the scan period T0004, the 362nd group of scan lines G362 (A+K equals 362) of the start frame SFrame or frames Frame1 to FrameN is scanned.

By analogy, during the scan period T2159, the 1080th group of scan lines G1080 (A equals 1080) of the start frame SFrame or frames Frame1 to FrameN is scanned. During the scan period T2160, the 1440th group of scan lines G1440 (A+K equals 1440) of the start frame SFrame or frames Frame1 to FrameN is scanned. During the scan period T2161, the 1081st group of scan lines G1081 (A equals 1081) of the start frame SFrame or frames Frame1 to FrameN is scanned. During the scan period T2162, the first group of scan lines G1 (A+K equals 1441, but exceeds 1440 (M), thus the first group of scan lines G1 is scanned) of the start frame SFrame or frames Frame1 to FrameN is scanned.

By analogy, during the scan period T2879, the 1440th scan line G1440 is scanned (that is, the Ath scan line is scanned, A is 1440). During the scan period T2880, the display controller 120 controls the gate driver on array 130 to scan the 360th scan line G360 (that is, the (A+K-M)th scan line is scanned, A is 1440 and K is 360). Then, if continuing to update the frame, the display controller 120 cyclically counts A from 1440 to 1, and returns from the scan period T2880 to the scan period T0001, to continue cyclically performing “span interlaced scanning” starting from the scan period T0001 in FIG. 5.

In FIG. 5, the scan lines of adjacent scan periods are separated by K groups of scan lines. For example, the scan line G1 in the scan period T0001 and the scan line G361 in the scan period T0002 are separated by K (360) groups of scan lines; the scan line G2 in the scan period T0003 and the scan line G362 in the scan period T0004 are separated by K (360) groups of scan lines, as indicated by the mark 510.

Returning to FIG. 2 and FIG. 3, in step S226, during the third time period TP3 after the second time period TP2, the display controller 120 sequentially scans from the (M-K+1)th group (such as the 1081st group of scan lines G1081) of scan lines of the ending frame EFrame to the Mth group of scan lines (such as the 1440th group of scan lines G1440). The ending frame EFrame is mainly to enable the unfinished second trigger transmission to completely finish scanning the entire frame.

FIG. 6 is a detailed example schematic diagram illustrating interlaced scanning with spanning multiple groups of scan lines in the third time period TP3 according to a first embodiment of the disclosure. Similar to FIG. 4, FIG. 6 is illustrated according to the scan lines G1081 to G1440 driven in each ending frame EFrame and the driven time. During the third time period TP3, according to the unfinished second trigger transmission, the 1081st group of scan lines G1081 to the 1440th group of scan lines G1440 of the ending frame EFrame are sequentially scanned.

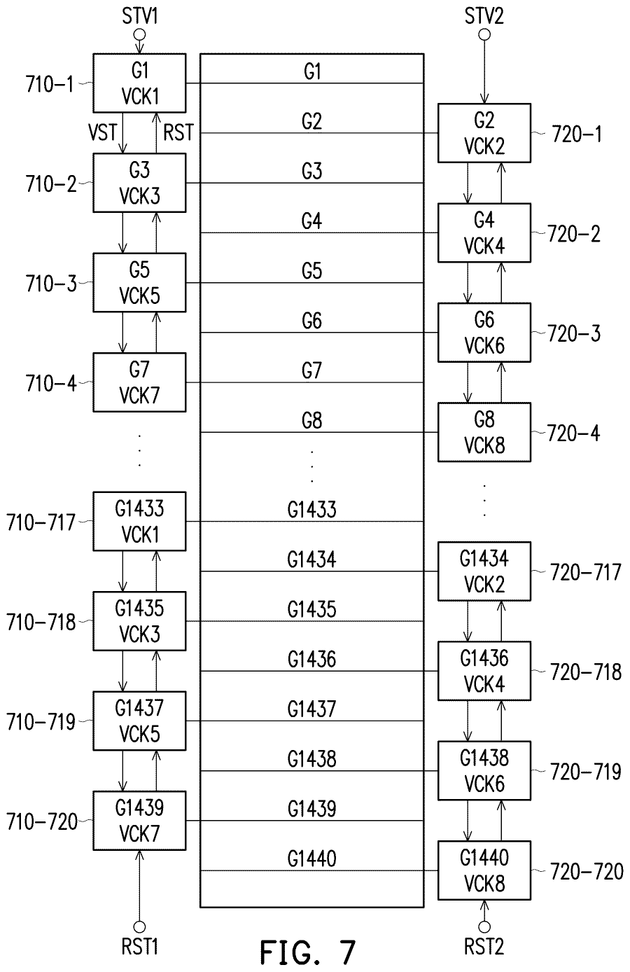

The gate driver on array of the embodiment of the disclosure may be implemented by various circuit structures to enhance driving performance. Here, the circuit structure of FIG. 7 is used as an example for illustration.

FIG. 7 is a schematic diagram illustrating a detailed structure of a gate driver on array according to a first embodiment of the disclosure. FIG. 7 takes an EPD panel 110 with 1920×1440 resolution as an example. The gate driver on array 130 in FIG. 1 may include 720 (i.e., N/2) first gate selection circuits 710-1 to 710-720 and 720 (i.e., N/2) second gate selection circuits 720-1 to 720-720 in FIG. 7. The first gate selection circuits 710-1 to 710-720 and the second gate selection circuits 720-1 to 720-720 may respectively be gate array stage (GOA stage) circuits.

The gate driver on array circuit structure shown in FIG. 7 may be referred to as a single-side input gate array circuit architecture, where each scan line G1 to G1440 is respectively driven by a single gate selection circuit, such as one of the first gate selection circuits 710-1 to 710-720 or the second gate selection circuits 720-1 to 720-720.

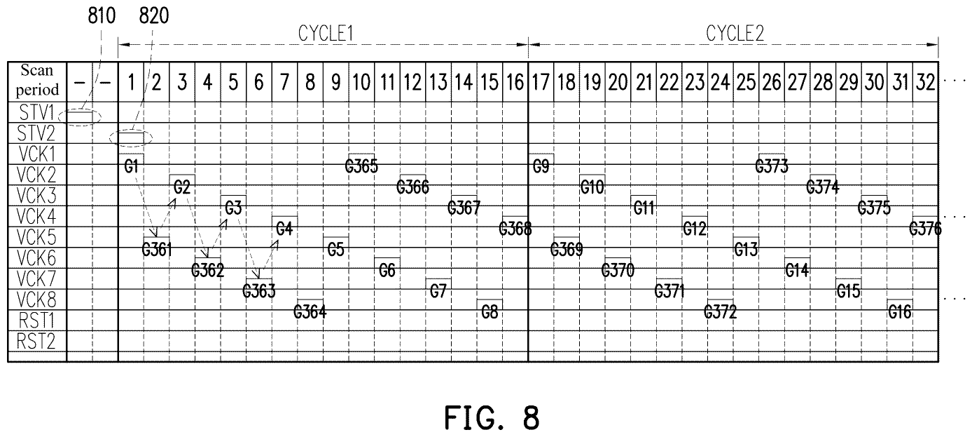

The present embodiment utilizes an enable signal STV1, an enable signal STV2, multiple voltage-controlled clock signals VCK1 to VCK8, a reset signal RST1, and a reset signal RST2 to control these gate selection circuits. The quantity of voltage-controlled clock signals may be correspondingly adjusted according to the requirements of those applying the present embodiment. In the present embodiment, the quantity of voltage-controlled clock signals may be defined as P, where P is greater than 1 and is a positive integer. In the embodiments of FIG. 7 and FIG. 8, ‘8’ is used as an example of P.

The first gate selection circuits 710-1 to 710-720 of the present embodiment are set on the first side of the EPD panel 110 (such as the left side of FIG. 7). Each of the first gate selection circuits 710-1 to 710-720 is respectively coupled to one of the odd-numbered scan lines among the 1440 scan lines. For example, the first gate selection circuit 710-1 is coupled to the scan line G1, the first gate selection circuit 710-2 is coupled to the scan line G3, the first gate selection circuit 710-3 is coupled to the scan line G5, and so on. The first gate selection circuits 710-1 to 710-720 are controlled by the enable signal STV1, the voltage-controlled clock signals VCK1, VCK3, VCK5, VCK7, and the reset signal RST1.

The signal transmission method of the gate selection circuits is that the previous stage first gate selection circuit (such as the first gate selection circuit 710-1) transmits to the next stage first gate selection circuit (such as the first gate selection circuit 710-2), allowing each stage of gate selection circuit to sequentially scan or output data to each scan line. For example, the previous stage first gate selection circuit (such as the first gate selection circuit 710-1) provides a signal VST to the next stage first gate selection circuit (such as the first gate selection circuit 710-2) to be configured as a set trigger, so that the next stage first gate selection circuit (such as the first gate selection circuit 710-2) scans the corresponding scan line due to the corresponding voltage-controlled clock signal (such as the voltage-controlled clock signal VCK3). In response to the previous stage first gate selection circuit performing a set trigger on the next stage first gate selection circuit, and the scan line numbers corresponding to the previous stage and the next stage first gate selection circuits differ by a value (such as value X), the present embodiment refers to this scan line driving method as ‘GN+X’.

On the other hand, the next stage first gate selection circuit (such as the first gate selection circuit 710-2) provides a signal RST to the previous stage first gate selection circuit (such as the first gate selection circuit 710-1) to be configured as a reset trigger, so that the previous stage first gate selection circuit (such as the first gate selection circuit 710-1) does not scan the corresponding scan line due to the corresponding voltage-controlled clock signal (such as the voltage-controlled clock signal VCK1). When the next stage first gate selection circuit performs a reset trigger on the previous stage first gate selection circuit, and the scan line numbers corresponding to the previous stage and the next stage first gate selection circuits also differ by the value X, the present embodiment refers to this scan line driving method as ‘GN+−X’.

The embodiment of the disclosure may selectively and sequentially scan odd-numbered scan lines by adjusting the enable signal STV1, the voltage-controlled clock signals VCK1, VCK3, VCK5, VCK7, and the reset signal RST1.

For example, in response to a certain gate selection circuit 710-N (such as the first gate selection circuit 710-3) being configured as a set trigger, if this gate selection circuit 710-N (such as the first gate selection circuit 710-3) receives the corresponding and enabled voltage-controlled clock signal (such as the voltage-controlled clock signal VCK5 corresponding to the first gate selection circuit 710-3 is enabled), the corresponding scan line G5 is scanned. In contrast, in response to a certain gate selection circuit 710-N (such as the first gate selection circuit 710-719) being configured as a reset trigger, this gate selection circuit 710-N (such as the first gate selection circuit 710-719) does not scan the corresponding scan line G1437 regardless of whether the voltage-controlled clock signal VCK5 is enabled or not.

The second gate selection circuits 720-1 to 720-720 are disposed on the second side of the EPD panel 110 (such as the right side of FIG. 7). Each of the second gate selection circuits 720-1 to 720-720 is respectively coupled to one of the even-numbered scan lines among the 1440 scan lines. For example, the second gate selection circuit 720-1 is coupled to the scan line G2, the second gate selection circuit 720-2 is coupled to the scan line G4, the second gate selection circuit 720-3 is coupled to the scan line G6, and so on. The second gate selection circuits 720-1 to 720-720 are controlled by the enable signal STV2, the voltage-controlled clock signals VCK2, VCK4, VCK6, VCK8, and the reset signal RST2.

Similar to the control mechanism of the first gate selection circuits 710-1 to 710-720, the embodiment of the disclosure may selectively and sequentially scan even-numbered scan lines by adjusting the enable signal STV2, the voltage-controlled clock signals VCK2, VCK4, VCK6, VCK8, and the reset signal RST2.

FIG. 8 is a signal waveform diagram of the enable signals STV1 to STV2, the voltage-controlled clock signals VCK1 to VCK8, and the reset signals RST1 to RST2 in FIG. 7. FIG. 8 presents the corresponding signals of the scan periods T0001 to T0032 in the second time period TP2 of FIG. 5. Referring to FIG. 7 and FIG. 8 simultaneously, when scanning the frame in the EPD panel 110, the enable signal STV1 is enabled in advance (mark 810), and the first gate selection circuit 710-1 is thus configured as a set trigger.

The gate driver on array of this embodiment is controlled by 8 voltage-controlled clock signals VCK1 to VCK8. The time for scanning one frame in the EPD panel 110 is divided into 2880 scan periods (such as the scan periods T0001 to T2880 in FIG. 5). The scan periods T0001 to T0032 in FIG. 5 respectively correspond to the 1st to 32nd scan periods in FIG. 8, as an example for illustration.

Taking the cycle CYCLE1 in FIG. 8 as an example, the voltage-controlled clock signal VCK1 is enabled once at the first scan period, and the voltage-controlled clock signal VCK1 is enabled again at the tenth scan period; the voltage-controlled clock signal VCK2 is enabled at the third scan period, and the voltage-controlled clock signal VCK2 is enabled again at the twelfth scan period.

At the first scan period of the cycle CYCLE1, the voltage-controlled clock signal VCK1 is enabled, so that the first gate selection circuit 710-1 configured as a set trigger thus scans the corresponding scan line G1. Further, the first gate selection circuit 710-1 provides a signal VST to the next stage first gate selection circuit 710-2 to be configured as a set trigger. Then, the next stage first gate selection circuit 710-2 provides a signal RST to the previous stage first gate selection circuit 710-1 to be configured as a reset trigger. The first gate selection circuit 710-1 further provides a signal VST to the first gate selection circuit 710-181 (not shown) to be configured as a set trigger. On the other hand, at the scan period 1, the enable signal STV2 is enabled (mark 820), and the second gate selection circuit 720-1 is thus configured as a set trigger.

At the second scan period, the voltage-controlled clock signal VCK5 is enabled, so that the first gate selection circuit 710-181 (not shown) scans the corresponding scan line G361. Then, the next stage first gate selection circuit 710-182 is configured as a set trigger, and the first gate selection circuit 710-181 (not shown) is configured as a reset trigger after scanning the scan line G361.

At the third scan period, the voltage-controlled clock signal VCK2 is enabled, so that the second gate selection circuit 720-1 scans the corresponding scan line G2. Then, the next stage second gate selection circuit 720-2 is configured as a set trigger, and the second gate selection circuit 720-1 is configured as a reset trigger after scanning the scan line G2. The second gate selection circuit 720-1 further provides a signal VST to the second gate selection circuit 720-181 (not shown) to be configured as a set trigger.

At the fourth scan period, the voltage-controlled clock signal VCK6 is enabled, so that the second gate selection circuit 720-181 (not shown) scans the corresponding scan line G362. Then, the next stage second gate selection circuit 720-182 (not shown) is configured as a set trigger, and the second gate selection circuit 720-181 is configured as a reset trigger after scanning the scan line G362. The subsequent operations follow the same manner.

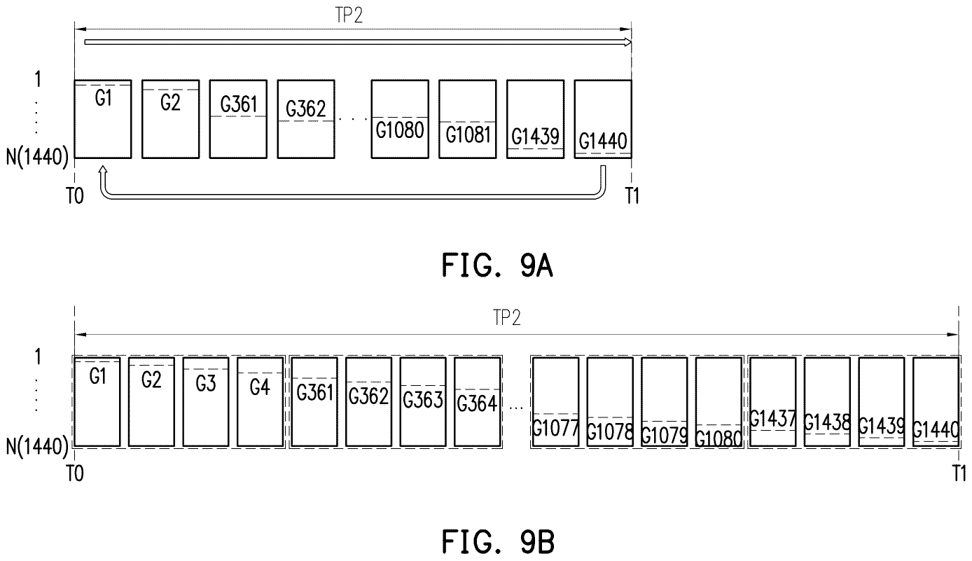

The first embodiment of FIG. 3 to FIG. 8 is configured with each group having only one scan line, that is, M equals N. It is defined herein that each group of scan lines has Q scan lines, where Q is a positive integer. FIG. 9A and FIG. 9B are schematic diagrams illustrating interlaced scanning with spanning multiple groups of scan lines implemented by each group of scan lines having 2 or 4 scan lines according to various embodiments of the disclosure. FIG. 9A presents a schematic diagram when each group of scan lines has 2 scan lines, that is, Q equals 2. Referring to FIG. 9A, when scanning the first group of scan lines, that is, A equals 1, two adjacent scan lines G1 and G2 are scanned sequentially. Then, based on the span interlaced scanning of the present embodiment, the (A+K)th group of scan lines is scanned next. In the present embodiment, A equals 1 and K equals 180, thus the 181st group of scan lines is scanned, that is, two adjacent scan lines G361 and G362 are scanned sequentially. Next, the second group of scan lines is scanned (A equals 2, that is, adjacent scan lines G3 and G4 are scanned sequentially), and then the 182nd group of scan lines is scanned (A equals 2 and K equals 180, that is, adjacent scan lines G363 and G364 are scanned sequentially), and so on.

FIG. 9B presents a schematic diagram when each group of scan lines has 4 scan lines, that is, Q equals 4. Referring to FIG. 9B, when scanning the first group of scan lines, A equals 1, and adjacent scan lines G1 to G4 are scanned sequentially. Then, based on the span interlaced scanning of the present embodiment, the (A+K)th group of scan lines is scanned next. In the present embodiment, A equals 1 and K equals 90, thus the 91st group of scan lines is scanned, that is, adjacent scan lines G361 to G364 are scanned sequentially. Next, the second group of scan lines is scanned (A equals 2, that is, adjacent scan lines G5 to G8 are scanned sequentially), and then the 92nd group of scan lines is scanned (A equals 2 and K equals 90, that is, adjacent scan lines G365 to G368 are scanned sequentially), and so on.

FIG. 9A or FIG. 9B adopts scan grouping while using the aforementioned interlaced scanning, configuring each group of scan lines to have more than one scan line, which may enable the data driver to effectively reduce the interlace count of the output data, and may further reduce the frame flickering sensation of the electronic paper display when switching frames. In practical applications, the trigger sequence of the voltage-controlled clock signals is required to be adjusted accordingly based on the quantity of voltage-controlled clock signals (such as the voltage-controlled clock signals VCK1 to VCK8 of the present embodiment) and the quantity of each group of scan lines, so as to conform to the scan grouping described in FIG. 9A or FIG. 9B.

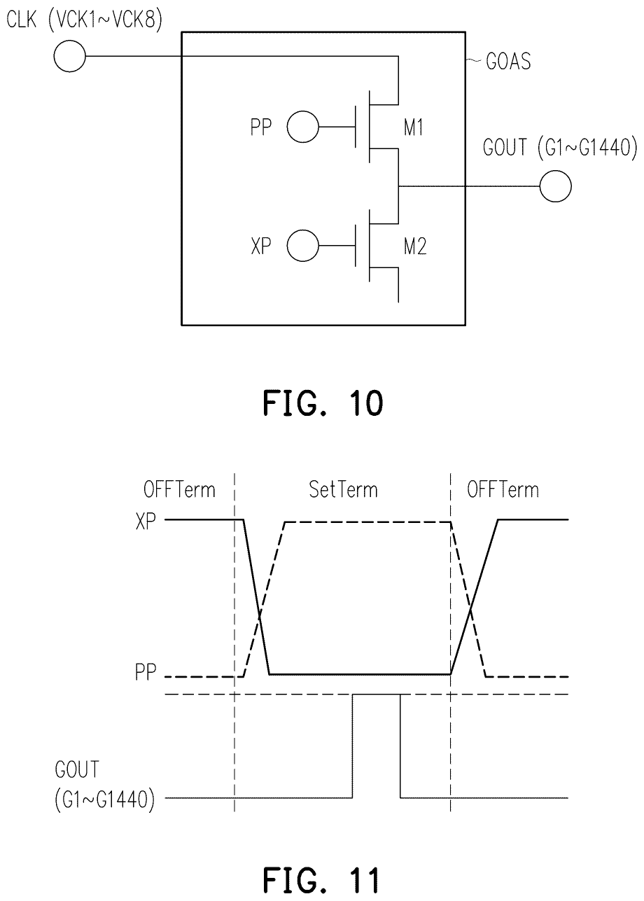

FIG. 10 is a circuit structure diagram of a gate array stage (GOA stage) circuit GOAS when each group of scan lines has 4 scan lines according to a second embodiment of the disclosure. FIG. 11 is a schematic diagram of signal waveforms of each signal in the gate array stage circuit of FIG. 10. The gate array stage circuit GOAS of FIG. 10 is the circuit structure of any one of the first gate selection circuits 710-1 to 710-720 and the second gate selection circuits 720-1 to 720-720 in FIG. 7.

The gate array stage circuit GOAS of FIG. 10 has two transistors M1 and M2. A first terminal (such as a drain terminal) of the transistor M1 receives a clock signal CLK. The clock signal CLK of the present embodiment may be one of the voltage-controlled clock signals VCK1 to VCK8. A control terminal of the transistor M1 is coupled to an endpoint PP. A control terminal of the transistor M2 is coupled to an endpoint XP. A second terminal (such as a source terminal) of the transistor M1 is coupled to a first terminal (such as a drain terminal) of the transistor M2 to become an output terminal GOUT of the gate array stage circuit GOAS of FIG. 10. The output terminal GOUT may be coupled to one of the scan lines G1 to G1440.

Referring to FIG. 10 and FIG. 11 simultaneously, during the set trigger stage SetTerm, the endpoint PP in the gate array stage circuit GOAS rises from a low level to a high level, and the endpoint XP drops from a high level to a low level. When the clock signal CLK is triggered at this time, the output terminal GOUT of the gate array stage circuit GOAS is enabled, as shown by the output terminal GOUT in FIG. 11. That is, the period during which the endpoint PP is at a high level in the set trigger stage SetTerm is longer than the trigger period of the clock signal CLK. During other stages OFFTerm that are not the set trigger stage, the endpoint PP remains at a low level and the endpoint XP remains at a high level.

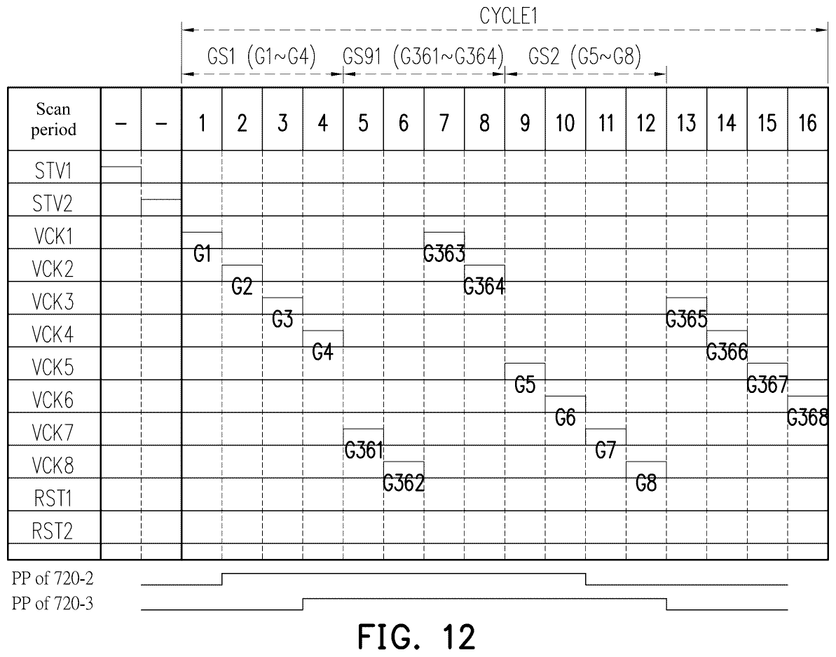

FIG. 12 is a signal waveform diagram of the enable signals STV1 to STV2, the voltage-controlled clock signals VCK1 to VCK8, and the reset signals RST1 to RST2 in the second embodiment conforming to FIG. 9B. Referring to FIG. 9A, FIG. 9B, and FIG. 12 simultaneously, considering the period during which the endpoint PP of each gate selection circuit is at a high level, the quantity of the voltage-controlled clock signals VCK1 to VCK8 is 8, and each group of scan lines in FIG. 9B has 4 scan lines, the present embodiment triggers the voltage-controlled clock signals VCK1 to VCK8 sequentially in groups of four, for example, sequentially triggering the voltage-controlled clock signals VCK1 to VCK4 in the first to fourth scan periods in FIG. 12 to scan the first group of scan lines GS1 (G1 to G4).

Furthermore, after scanning the first group of scan lines GS1, two of the voltage-controlled clock signals VCK1 to VCK8 are skipped, for example, the voltage-controlled clock signals VCK5 to VCK6 are skipped, and the voltage-controlled clock signals VCK7, VCK8, VCK1, and VCK2 are sequentially triggered in the fifth to eighth scan periods to scan the 91st group of scan lines GS91 (G361 to G364).

After scanning the 91st group of scan lines GS91, two of the voltage-controlled clock signals VCK1 to VCK8 are skipped, for example, the voltage-controlled clock signals VCK3 to VCK4 are skipped, and the voltage-controlled clock signals VCK5 to VCK8 are sequentially triggered in the ninth to twelfth scan periods to scan the second group of scan lines GS2 (G5 to G8), and so on.

Considering the second gate selection circuits 720-1 to 720-720 in FIG. 7, referring to FIG. 12, the endpoint PP of the second gate selection circuit 720-2 is enabled (at a high level) in the second scan period and continues until the tenth scan period. On the other hand, the endpoint PP of the second gate selection circuit 720-3 is enabled (at a high level) in the fourth scan period and continues until the twelfth scan period. Thus, during the period of scanning the 91st group of scan lines GS91 (that is, the fourth to eighth scan periods), the voltage-controlled clock signals VCK4 and VCK6 need to be prohibited from triggering, otherwise triggering errors occur in the second gate selection circuits 720-2 and 720-3. Similar situations also occur in the first gate selection circuits 710-1 to 710-720 in FIG. 7.

Thus, in the case where the quantity of the voltage-controlled clock signals VCK1 to VCK8 is 8 and each group of scan lines has 4 scan lines in FIG. 9B, the voltage-controlled clock signals VCK1 to VCK8 are triggered sequentially in groups of four (e.g., triggering the voltage-controlled clock signals VCK1 to VCK4), and after triggering, two voltage-controlled clock signals after the triggered voltage-controlled clock signals VCK1 to VCK8 are skipped (e.g., skipping the voltage-controlled clock signals VCK5 to VCK6), and the next four voltage-controlled clock signals VCK1 to VCK8 after the skipped ones are triggered (e.g., triggering the voltage-controlled clock signals VCK7, VCK8, VCK1, and VCK2).

X in this embodiment refers to the aforementioned value X of the difference in the numbers of the scan lines corresponding to the first gate selection circuit of the previous stage and the next stage in “GN+−X”, that is, the interval count for driving scan lines is X, and X is 2 in the embodiment of FIG. 7. P refers to the quantity of voltage-controlled clock signals. During the period of scanning the next group of scan lines (e.g., the period of scanning the 91st group of scan lines GS91), the corresponding gate selection circuit makes its endpoint PP at a high level, and during the period of scanning the previous group of scan lines (e.g., the period of scanning the first group of scan lines GS1), the endpoints PP in multiple gate selection circuits (e.g., 2X (4) gate selection circuits) are still at a high level. Thus, the quantity of voltage-controlled clock signals that may be used to control the corresponding gate selection circuits is reduced by 2X (4), and the remaining quantity of available voltage-controlled clock signals is “P-2X”. The maximum number of scan groups during the period of scanning the next group of scan lines (e.g., the period of scanning the 91 st group of scan lines GS91) is the quantity of available voltage-controlled clock signals. That is, in the case where each group of scan lines has Q scan lines, the maximum value of Q is less than or equal to “P-2X”. Q equals N/M, and Q is a positive integer.

Here, based on the value X and the quantity P of voltage-controlled clock signals, the quantity of Q scan lines that each group of scan lines may have is calculated, and examples are listed in Table (1). Those applying this embodiment may appropriately adjust the circuit structure of the gate driver on array 130 in the electronic paper display device 100 according to their requirements and according to the rule that “the maximum value of Q is equal to ‘P-2X’”, and are not limited to the examples in Table (1) and may be infinitely expanded in theory.

TABLE 1

| | P (quantity | Q (quantity of scan lines |
|---|---|---|
| X in GN +− X | of VCK) | in each group of scan lines) |
| 1 | 4 | 1, 2 |
| 1 | 8 | 1, 2, 6 |
| 2 | 8 | 1, 2, 4 |
| 2 | 12 | 1, 2, 4, 8 |
| 2 | 16 | 1, 2, 4, 8, 12 |
| 2 | 20 | 1, 2, 4, 8, 12, 16 |
| 4 | 16 | 1, 2, 4, 8 |

In summary, the embodiments of the disclosure perform frame scanning and updating on the electronic paper display through interlaced scanning with scan lines spanning a fixed number of groups, so as to reduce the frame flickering of the electronic paper display when switching frames. In this embodiment, the trigger signal Vst is triggered twice in the same frame, thereby generating two trigger transmissions for the gate driver on array (GOA), allowing these two trigger transmissions to be performed simultaneously, thereby implementing interlaced scanning of the scan line signals in the gate array. The embodiment of the disclosure also has corresponding start frame and ending frame before and after performing the interlaced scan, thereby further improving the corresponding implementation details of the interlaced scan. Furthermore, this embodiment may adopt scan grouping while using the aforementioned interlaced scanning, configuring each group of scan lines to have more than one scan line, which may enable the data driver to effectively reduce the interlace count of the output data, and may further reduce the frame flickering of the electronic paper display when switching frames.

Although the present invention has been disclosed above with embodiments, they are not intended to limit the present invention. Any person having ordinary knowledge in the technical field may make some modifications and refinements without departing from the spirit and scope of the present invention. Therefore, the protection scope of the present invention shall be defined by the appended claims.

What is claimed is:

1. A driving method for an electronic paper display device, wherein an electronic paper display panel and a gate driver on array in the electronic paper display device are disposed on an electronic paper display substrate, the electronic paper display panel comprises N scan lines, wherein the N scan lines are divided into M groups of scan lines, each of the M groups of scan lines comprises at least one scan line, wherein N and M are positive integers and N is an even number, the driving method comprising:
performing interlaced scanning with spanning K groups of scan lines on the M groups of scan lines in the electronic paper display panel based on controlling the gate driver on array, wherein K is less than M and K is a positive integer,
wherein the interlaced scanning with spanning the K groups of scan lines comprises:
at a first time period, sequentially scanning from a first group of scan lines of a start frame to a Kth group of scan lines of the start frame; and
at a second time period after the first time period, scanning an Ath group of scan lines in the start frame and a plurality of frames, then scanning an (A+K)th group of scan lines, wherein A is a positive integer of a cycle count, and 1≤A≤M.

2. The driving method according to claim 1, wherein the interlaced scanning with spanning the K groups of scan lines further comprises:
at a third time period after the second time period, sequentially scanning from an (M−K+1)th group of scan lines of an ending frame to an Mth group of scan lines, wherein the ending frame is presented after the plurality of frames.

3. The driving method according to claim 1, wherein
in response to A+K being greater than M, scanning an (A+K)th group of scan lines is changed to scanning an (A+K−M)th group of scan lines, and
in response to A+1 being greater than M, scanning an (A+1)th group of scan lines is changed to scanning an (A+1−M)th group of scan lines.

4. The driving method according to claim 1, wherein in response to N being equal to M, K is N/4, N/3, or 3N/4.

5. The driving method according to claim 1, wherein each of the M groups of scan lines has 1 scan line, 2 scan lines, or 4 scan lines.

6. The driving method according to claim 1, wherein an interval count for driving the scan lines is X, a quantity of voltage-controlled clock signals is P, each group of scan lines has Q scan lines, X, P, and Q are positive integers, and a maximum value of Q is less than or equal to P-2X.

7. The driving method according to claim 1, wherein the gate driver on array comprises:
N/2 first gate selection circuits, each of the first gate selection circuits respectively coupled to one of odd-numbered scan lines among the N scan lines, wherein the first gate selection circuits are controlled by a first enable signal; and
N/2 second gate selection circuits, each of the second gate selection circuits respectively coupled to one of even-numbered scan lines among the N scan lines, wherein the second gate selection circuits are controlled by a second enable signal.

8. An electronic paper display device, comprising:
an electronic paper display panel, comprising N scan lines, wherein the N scan lines are divided into M groups of scan lines, each of the M groups of scan lines comprises at least one scan line, and N and M are positive integers and Nis an even number;
a display controller; and
a gate driver on array, coupled to the display controller and the electronic paper display panel, wherein the electronic paper display panel and the gate driver on array are disposed on an electronic paper display substrate,
wherein the display controller controls the gate driver on array so as to perform interlaced scanning with spanning K groups of scan lines on the M groups of scan lines in the electronic paper display panel, wherein K is less than M and K is a positive integer,
wherein the interlaced scanning with spanning the K groups of scan lines comprises:
at a first time period, sequentially scanning from a first group of scan lines of a start frame to a Kth group of scan lines of the start frame; and
at a second time period after the first time period, scanning an Ath group of scan lines in the start frame and a plurality of frames, then scanning an (A+K)th group of scan lines, wherein A is a positive integer of a cycle count, and 1≤A≤M.

9. The electronic paper display device according to claim 8, wherein the interlaced scanning with spanning the K groups of scan lines further comprises:
at a third time period after the second time period, sequentially scanning from an (M−K+1)th group of scan lines of an ending frame to an Mth group of scan lines, wherein the ending frame is presented after the plurality of frames.

10. The electronic paper display device according to claim 8, wherein
in response to A+K being greater than M, scanning an (A+K)th group of scan lines is changed to scanning an (A+K−M)th group of scan lines, and
in response to A+1 being greater than M, scanning an (A+1)th group of scan lines is changed to scanning an (A+1−M)th group of scan lines.

11. The electronic paper display device according to claim 8, wherein in response to N being equal to M, K is N/4, N/3, or 3N/4.

12. The electronic paper display device according to claim 8, wherein each of the M groups of scan lines has 1 scan line, 2 scan lines, or 4 scan lines.

13. The electronic paper display device according to claim 8, wherein an interval count for driving the scan lines is X, a quantity of voltage-controlled clock signals is P, each group of scan lines has Q scan lines, X, P, and Q are positive integers, and a maximum value of Q is less than or equal to P-2X.

14. The electronic paper display device according to claim 8, wherein the gate driver on array comprises:
N/2 first gate selection circuits, each of the first gate selection circuits respectively coupled to one of odd-numbered scan lines among the N scan lines, wherein the first gate selection circuits are controlled by a first enable signal; and
N/2 second gate selection circuits, each of the second gate selection circuits respectively coupled to one of even-numbered scan lines among the N scan lines, wherein the second gate selection circuits are controlled by a second enable signal.
